(19) United States
(12) Patent Application Publication
(10) Pub. No.: US 2025/0243046 A1
(43) Pub. Date: Jul. 31, 2025

(54) METHOD AND SYSTEM FOR CARBONATED FILLING OF CONTAINERS

(71) Applicant: KRONES AG, Neutraubling (DE)

(72) Inventor: Valentin BECHER, Donaustauf (DE)

(21) Appl. No.: 19/042,491

(22) Filed: Jan. 31, 2025

(30) Foreign Application Priority Data
Jan. 31, 2024 (DE) 10 2024 102 693.6

(51) Int. Cl. B67C 3/06; B67C 3/12; B67C 7/00

(52) U.S. Cl. CPC B67C 3/065; B67C 3/12; B67C 7/00

(57) ABSTRACT

The invention relates, inter alia, to a method for filling a liquid into a container. The method comprises carbonating the liquid using a carbonator. The method comprises continuously reducing a pressure of the carbonated liquid to below a saturation pressure of carbon dioxide in the carbonated liquid and to above or substantially equal to an ambient pressure using a filling valve. The method further comprises filling the container with the pressure-reduced liquid using the filling valve.

### CROSS-REFERENCE TO RELATED APPLICATIONS

### Technical Field

The invention relates to a method for filling a liquid into a container. The invention further relates to a system for filling a liquid into containers.

### Technical Background

Carbonated beverages are currently filled in high-performance filling systems using either the equal pressure or differential pressure method. The most common equal pressure method is the counter-pressure filling method, in which the storage container and the container to be filled are under the same, increased pressure. In the differential pressure method, the container is placed under vacuum before the liquid flow into the container starts.

In the differential pressure method, partially dissolved gases escape from the liquid at the beginning of the process, but are quickly redissolved as the pressure rapidly builds during the process. The vacuum method only works with vacuum-resistant containers (glass, reusable PET) and performs better with highly foaming products.

In the counter-pressure filling method, the container is brought to the same pressure or a pressure very close to the pressure in the filling vessel prior to filling. The filling process is carried out at this pressure level. After filling, the container must be depressurized so that it can be transported to the capper without pressure. Filling takes place at a pressure at or above the saturation pressure of the bound CO2 in the liquid. If the pressure in the filling vessel and/or in the container is lower, excessive release of the dissolved gases in the filled beverage occurs during depressurization, leading to overfoaming and, consequently, an unacceptable loss of liquid and CO2.

Since the saturation pressure of CO2 in liquids depends strongly on the temperature of the liquid, carbonated beverages are usually filled below ambient temperature. The closer the beverage is to the freezing point, the lower the saturation pressure and, consequently, the lower the filling pressure. However, the beverage must be cooled for this purpose before the filling process. In order to save energy during the filling process, there is a trend toward increasing the filling temperature to a level where no cooling or heating is necessary, i.e., filling at ambient temperature. In the counter-pressure method, the necessary pressure in the container must be further increased during filling, depending on the filling temperature.

Both the counter-pressure filling method and the differential pressure method subject the container to stresses that differ from those it will later be subjected to when closed and when consumed by the customer. As a result, either the filling technology must be made more complex and/or the container itself must be dimensioned for the filling process. This leads to considerable additional costs. Since the cost of the containers accounts for by far the largest share of the operating costs of a filling system for most products, additional requirements imposed on the container by the filling method quickly become costly.

Raising the filling temperature to save cooling energy significantly increases the requirements for the pressure stability of the container due to the rising filling pressure.

This can either be addressed by using a more pressure-stable container or by applying the necessary minimum cooling to avoid exceeding a certain filling pressure.

In addition, in the equal-pressure or counter-pressure filling method, the pressure build-up and depressurization step takes several seconds, which corresponds to a considerable proportion of the total process time. Therefore, additional filling stations must be used in the filling machines, leading to increased construction and maintenance costs.

The invention addresses the problem of creating an improved technique for filling carbonated liquids.

### SUMMARY OF THE INVENTION

The object is achieved by the features of the independent claims. Advantageous developments are specified in the dependent claims and the description.

One aspect of the present disclosure relates to a method for filling a liquid into a container, preferably by a system as disclosed herein. The method includes carbonating the liquid using a carbonator. The method comprises continuously reducing a pressure of the carbonated liquid to below a saturation pressure of carbon dioxide in the carbonated liquid and to above or substantially equal to an ambient pressure using a (e.g. adjustable via closed-loop or open-loop control) filling valve (e.g. using a throttle element of the filling valve, which is preferably conical and/or adjustable using an actuator). The method further comprises filling the container with the pressure-reduced liquid using the filling valve (e.g., by opening a shut-off element of the filling valve).

The filling method advantageously reduces or entirely eliminates the need to increase the pressure applied to the container during filling as the temperature of the filled beverage increases. In pressureless filling, there is no longer any connection between the pressure load on the container during filling and the filling temperature. This leads to lower requirements for the container, the filling valve, and the protection of the operator against containers bursting during the filling process, thus resulting in cost savings. The shorter or eliminated filling process steps for pressure build-up and reduction in the container advantageously reduce the overall process time, thus requiring fewer filling valves, a smaller machine size and less maintenance effort. Due to the lower pressure in the container, the consumption of gases for any necessary rinsing of the container prior to filling can also be reduced, if oxygen uptake in the beverage is to be avoided. In a stable, pressureless filling process where the formation of microbubbles is prevented, filling is also easier to carry out because less process expertise is needed to avoid overfoaming. Operating a carbonated filler can then advantageously be as straightforward as operating a still water filler.

It has been recognized that the overfoaming of carbonated beverages during filling means that the release of bound gases (CO2 and O2) from the liquid is so intense, and the gases rising to the surface of the liquid produce so much stable foam, that the foam overflows from the container. Therefore, overfoaming can only be prevented by preventing or minimizing, as far as possible, the release of bound gases during the filling process. Gas homogeneously dissolved in the liquid is only released at such a high vacuum pressure approaching saturation pressure, which cannot occur during the filling process (Fischer Sven-Blasenbildung von in Flüssigkeiten gelösten Gasen-Munich: Technical University of Munich, 2001). The only mechanism for gas release is the growth of existing bubble nuclei. Bubble nuclei can form during the filling process of carbonated non-alcoholic beverages in the following process steps: (1) During the technical introduction of the gas into the liquid (carbonation), (2) during the initial wetting of surfaces with the liquid and (3) during entry of the liquid into a liquid surface. In addition, bubble nuclei can form in beverages during fermentation.

Advantageously, the continuous reduction of the liquid pressure during the filling phase, just before introduction into a container with the help of the filling valve, can reduce the growth of any (micro) gas bubbles that may be present. Pressure surges and turbulence are avoided. The required pressure in the container during filling can be reduced to varying degrees below the saturation pressure, depending on the number of microbubbles present in the beverage. Below a certain threshold of the number of microbubbles present, filling at ambient pressure is also possible.

It is possible that the carbonated liquid will have a temperature during the filling process that is close to or equal to ambient temperature.

Preferably, the method can also use techniques that largely prevent the formation of bubble nuclei, ensuring that no or as few microbubbles as possible are present in the beverage before filling. This advantageously enables a filling process that is not dependent on the saturation pressure. These techniques are described in the following preferred exemplary embodiments, among others.

In one exemplary embodiment, at least one of the following is fulfilled:
carbonation of the liquid is carried out using a membrane contactor carbonator, a cavitation carbonator, or a spray cone carbonator;
carbonation is carried out using a bubble-free or almost bubble-free carbonation process;
during carbonation, the liquid is vaporized into a gas and the gas is mixed with gaseous carbon dioxide, or gaseous carbon dioxide diffuses into the liquid during carbonation without being forced into it; and
a pressure of the liquid during carbonation corresponds at least to the saturation pressure (equilibrium pressure) of carbon dioxide in the liquid.

Advantageously, the carbonation of the liquid can thus be carried out using a technical method that works without the direct introduction of gas bubbles into the liquid.

The introduction of gas bubbles into a liquid can always result in microbubbles being formed in the liquid, which can act as bubble nuclei (Fischer Sven-Blasenbildung von in Flüssigkeiten gelösten Gasen-Munich: Technical University of Munich, 2001). Observations during the filling process and the behavior of filled beverages suggest that the microbubbles are largely dissolved after a few days but are present during the filling process. Due to the presence of these microbubbles, current filling processes for carbonated beverages must be carried out at saturation pressure or above. A bubble-free technology, such as carbonation with a membrane contactor, etc., which does not introduce gas bubbles into the beverage, prevents the formation of microbubbles.

In a further embodiment, the container is filled through a filling tube which is immersed in the container, or the container is filled by wall filling of the container, in which the liquid flows along an inner circumferential surface of the container as the container is filled. Alternatively or additionally, the container is not filled by free-jet filling. Advantageously, this allows the flow of liquid to be guided into the container in a manner that minimizes foaming as much as possible. Advantageously, the use of the filling tube can completely prevent entry of the liquid flow into a liquid surface. During wall-filling, the flow of liquid along the container wall can be slowed as it descends. The liquid can then slowly enter the liquid surface without much turbulence and swirling. However, with increased volume flow, wall-filling can also result in turbulent immersion, leading to the formation of bubbles (or bubble nuclei). However, these bubbles only lead to overfoaming if too many of them are created and/or if the pressure is reduced after the filling process. In the pressureless filling process, only the first factor is relevant and can be avoided by adjusting the flow velocity.

In one embodiment, when the container is filled with the pressure-reduced liquid, the internal pressure of the container corresponds to the pressure of the pressure-reduced liquid and/or the ambient pressure. Alternatively or additionally, filling can be carried out at ambient pressure or approximately ambient pressure.

Microbubbles that form when the container to be filled is wetted only lead to increased gas release if the container must be depressurized after filling. This is because the microbubbles expand more quickly due to the sudden drop in pressure than they can be reduced again through diffusion. Once they reach a certain size, they rise and continue to grow due to the diffusion of gas homogeneously dissolved in the beverage. However, in the pressureless filling process, they do not pose a problem because they do not increase in size.

In a further embodiment, the container is pressed against the filling valve during filling, preferably in a gas-tight or liquid-tight manner, during filling. Alternatively, the container can be spaced apart from the filling valve during filling.

In another embodiment, the method further comprises a flow of the carbonated liquid through a piping system to the filling valve, optionally with the interposition of a liquid reservoir, wherein at least one of the following conditions is met:
an internal surface of the piping system has a mean roughness value Ra≤0.8 (μm);
the piping system is free of dead zones, sudden expansions of the flow cross-section and/or sudden contractions of the flow cross-section; and
the maximum angle for continuous expansions of the flow cross-section and/or continuous contractions of the flow cross-section of the piping system is ≤6°.

Advantageously, microbubbles that form during the initial wetting of a surface with a liquid can be avoided or reduced through the described design of the piping system. This is achieved, for example, by ensuring that the surface is as smooth as possible and free of any possible nucleation sites for gas bubbles, so that gas residues cannot accumulate in uneven structures. This is especially important when filling the system for the first time. With prolonged operation, fewer and fewer microbubbles are entrained in the liquid flow.

Flow velocities in the piping system lead to a reduction in the dynamic pressure. If bubble nuclei are present, even pressures below the saturation pressure can cause the bubbles to grow, leading to gas release (pseudo-cavitation). If no bubble nuclei are present, the liquid only becomes gaseous when the vapor pressure of the mixture falls below the limit (cavitation). The presence of bubble nuclei therefore leads to further restrictions in the filling process. The piping system is therefore advantageously adapted so that the flow velocities and pressures in the piping system are adapted to the number of bubble nuclei present. If no bubble nuclei are present, only cavitation needs to be prevented. The greater the number of bubble nuclei, the lower the permissible velocities and the higher the required pressure. It is advantageous to have a piping system that is as short as possible between the carbonator and the filling valve. Increased flow velocities can be avoided, for example, by not using centrifugal pumps and only allowing a slow and steady pressure reduction in valves.

In one embodiment, the method further comprises storing the carbonated liquid in a liquid reservoir (e.g. liquid tank) before the pressure is reduced by the filling valve, wherein preferably the carbonated liquid is stored under a pressure which corresponds at least to the saturation pressure of carbon dioxide in the carbonated liquid.

In a further embodiment, the method further comprises degassing the liquid using a degasser, preferably before or during carbonation of the liquid, to reduce gaseous oxygen in the liquid.

In one embodiment, the liquid being carbonated is either pure water or water mixed with at least one additional filling material. Advantageously, in the variant in which only water is carbonated, contamination of the carbonator can be significantly reduced. The carbonator therefore needs to be cleaned less often.

In a further embodiment, the method further comprises metering at least one additional filling material into the liquid, preferably:
before carbonation; or
after carbonation and before reducing the pressure; or
into a mixing chamber of the filling valve (e.g. upstream or downstream of a throttle element of the filling valve).

As already explained, contamination of the carbonator can be significantly reduced by metering the additional filling material only after the liquid has been carbonated.

In one embodiment, the method further comprises sealing the filled container with a container closure using a closure apparatus (e.g. rotary closure apparatus). Alternatively or additionally, the container can, for example, be moved automatically for the purpose of filling and/or automatically moved away after filling. Alternatively or additionally, the method can be applied in a container treatment system. Alternatively or additionally, the filling valve can be one of several filling valves of a filling apparatus, preferably a rotary filling apparatus.

Alternatively or additionally, the container can move along a continuous production line (e.g. comprising at least one rotary machine, at least one intermittent-motion machine and/or at least one long-stator machine).

The container can be held during filling by a container support, e.g., on the container neck, the container neck ring, a container base, and/or a container bottom.

Another aspect of the present disclosure relates to a system for filling a liquid into containers, preferably using a method as disclosed herein. The system has a carbonator that is configured to carbonate the liquid. The system comprises a filling apparatus (e.g. rotary filling apparatus) having at least one (e.g. adjustable via closed-loop or open-loop control) filling valve connected to the carbonator in order to receive the carbonated liquid from the carbonator and is configured to:
continuously reduce the pressure of the carbonated liquid to below the saturation pressure and to above or substantially equal to an ambient pressure, preferably using a throttle element of the filling valve (e.g. conical and/or adjustable using an actuator), and
fill a container with the pressure-reduced liquid, preferably through a filling tube or by wall-filling the container.

Advantageously, the system can achieve the same advantages as already described with reference to the method. The same applies to the preferred exemplary embodiments of the system described below.

In one exemplary embodiment, the system comprises at least one of the following:
a liquid reservoir for storing the carbonated liquid, wherein the liquid reservoir is connected to the carbonator in order to receive the carbonated liquid and to the filling valve in order to supply the carbonated liquid to the filling valve;
a closure apparatus (e.g. rotary closure apparatus) for sealing filled containers with a container closure;
at least one additional filling material source which is connected to a pipeline portion upstream or downstream of the carbonator for metering an additional filling material into the liquid in the pipeline portion; or a mixing chamber of the filling valve for metering an additional filling material into the liquid in the mixing chamber (which is arranged, for example, upstream or downstream of a throttle element of the filling valve);
a liquid supply, preferably a water supply, wherein the liquid supply is connected to the carbonator in order to supply liquid (e.g. water) to the carbonator;
a degasser configured to reduce gaseous oxygen in the liquid and integrated with the carbonator or connected to the carbonator in order to supply the degassed liquid to the carbonator;
a lifting device configured to raise and lower the container and/or the filling valve, e.g., to press the filling valve and the container together;
a piping system connecting the carbonator and the filling valve, wherein the internal surface of the piping system has a mean roughness value Ra≤0.8; and/or being free of dead zones, sudden expansions of the flow cross-section and/or sudden contractions of the flow cross-section; and/or having a maximum angle for continuous flow cross-sectional expansions and continuous flow cross-sectional contractions of ≤6°.

In another exemplary embodiment:
the carbonator is a membrane contactor carbonator, a cavitation carbonator or a spray cone carbonator; and/or
the carbonator is configured to carry out a bubble-free or nearly bubble-free carbonation process, and/or
the carbonator is configured to vaporize the liquid into a gas during carbonization and to mix this gas with gaseous carbon dioxide, or to allow gaseous carbon dioxide to diffuse into the liquid during carbonation without the gaseous carbon being forced into the liquid; and/or
the carbonator is configured to carbonate the liquid at a pressure which corresponds at least to the saturation pressure (equilibrium pressure) of carbon dioxide in the liquid.

In one embodiment, the system is an industrial container treatment system, or the system is a small-scale system (local system) for placement in a supermarket or a train station, preferably with a footprint ≤10 sqm, ≤5 sqm, ≤3 sqm or ≤2 sqm.

The system can also be configured for temperature control, manufacturing, cleaning, coating, testing, pasteurizing, labeling, printing, marking, laser marking, and/or packaging of containers for liquid or pasty media, preferably beverages, liquid foodstuffs, or products from the pharmaceutical or healthcare industry.

For example, the containers can be realized as bottles, cans, canisters, cartons, vials, tubes, etc.

Preferably, the filling valve can be actuated using an actuator, e.g., via closed-loop or open-loop control.

The system can also comprise a container holder which is configured to hold the container during filling, e.g., on the container neck, the container neck ring, a container base, and/or a container bottom.

The preferred embodiments and features of the invention described above can be combined with one another as desired.

### BRIEF DESCRIPTION OF THE DRAWINGS

Further details and advantages of the invention are described below with reference to the accompanying drawings. In the figures:

FIG. 1 shows a schematic representation of a system according to an exemplary embodiment of the present disclosure;

FIG. 2 shows a flow diagram of an exemplary method according to an exemplary embodiment of the present disclosure;

FIG. 3 shows a schematic representation of a system according to an exemplary embodiment of the present disclosure; and

FIG. 4 shows a flow diagram of an exemplary method according to an exemplary embodiment of the present disclosure.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EXEMPLARY EMBODIMENTS

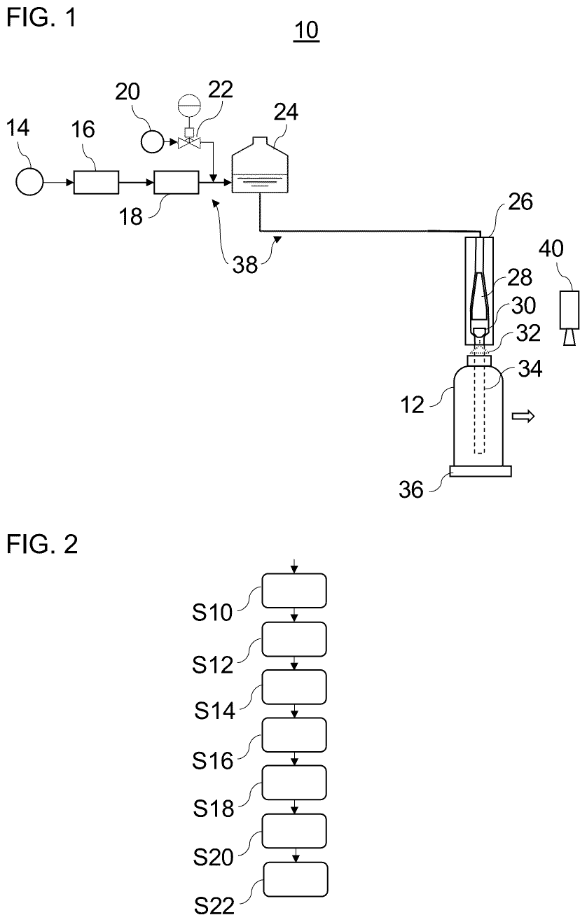

FIG. 1 shows a system 10 for filling containers 12.

Preferably, the system 10 can be an industrial container treatment system. However, it is also possible for the system 10 to be a small-scale system. The small-scale system can be set up, for example, in a supermarket or a train station or similar. The small-scale system can, for example, have a footprint of ≤10 sqm, ≤5 sqm, ≤3 sqm or ≤2 sqm.

The system 10 comprises a carbonator 18 and a filling valve 26. Optionally, the system 10 can also comprise, for example, a liquid supply 14, a degasser 16, an additional filling material source 20, a metering valve 22, a liquid reservoir 24, a piping system 38, and/or a closure apparatus 40.

The liquid supply 14 can provide a liquid for the system 10. Preferably, the liquid supply can provide water. The liquid supply can be, for example, a liquid tank (e.g., water tank) or a liquid connection (e.g., water connection).

The liquid supply 14 can be connected to the carbonator 18 in order to supply liquid to the carbonator 18, e.g., via the degasser 16 and/or via the piping system 38.

The degasser 16 can be configured to reduce gaseous oxygen in the liquid. The degasser 16 can receive the liquid from the liquid supply 14. The degasser 16 can reduce the gaseous oxygen in the received liquid, preferably water. The degasser 16 can reduce the gaseous oxygen in the liquid according to any suitable operating principle.

For example, the degasser 16 may reduce a proportion of gaseous oxygen in the liquid to ≤1 ppm, e.g., starting from ≥10 ppm upstream of the degasser 16.

The degasser 16 can be configured to reduce other gases in the liquid, e.g., carbon dioxide.

As shown in FIG. 1, the degasser 16 can, for example, be configured as a separate unit from the carbonator 18. The degasser 16 can then be connected to the carbonator 18 in order to supply the degassed liquid to the carbonator 18, e.g., via the piping system 38.

Alternatively, the degasser 16 can, for example, be integrated with the carbonator 18 (not shown in the figures). For example, the integrated apparatus can be realized as a membrane contactor-degasser-carbonator.

The carbonator 18 is configured to carbonate the liquid. Preferably, the carbonator 18 can carbonate the liquid at a liquid pressure of at least a saturation pressure of carbon dioxide of the liquid. During carbonation, gaseous carbon dioxide can be (physically) dissolved in the liquid and carbonic acid can be formed through a reaction with water.

Preferably, the carbonator 18 carbonates pure water. However, it is also possible for the carbonator 18 to carbonate another liquid, e.g., a mixture of pure water and at least one additive (e.g., syrup and/or flavorings).

The carbonator 18 preferably uses a bubble-free or nearly bubble-free carbonation process.

For this purpose, the carbonator 18 can operate according to a principle in which the gaseous carbon dioxide gradually diffuses into the liquid, e.g., at a substantially constant rate, instead of being forced into the liquid. The principle can be illustrated using a tank partially filled with the liquid, the headspace of which is filled with the gaseous carbon dioxide. Optionally, a mixing element (e.g. a stirrer) and/or a large contact surface between the gaseous carbon dioxide and the liquid can facilitate the diffusion process.

For example, the carbonator 18 can be a membrane contactor. The membrane contactor can comprise, for example, a microporous membrane structure with several membrane plates or hollow membrane fibers. The membrane structure allows the gaseous carbon dioxide and the liquid to come into contact with each other over a large area, allowing the gaseous carbon dioxide to diffuse broadly into the liquid.

Alternatively, the carbonator 18 can be, for example, a spray cone carbonator. This carbonator can comprise, for example, a conical flow body. The liquid can be passed over the flow body and sprayed from there in a fine dispersion into the gaseous carbon dioxide, allowing the gaseous carbon dioxide to diffuse broadly into the liquid.

It is also possible for the carbonator 18 to operate according to a principle in which the liquid is first vaporized into a gas. This gas can then be mixed with the gaseous carbon. Mixing can occur at the molecular level. During and/or after the mixing process, the mixture is restored to a liquid state, either naturally or through liquefaction.

For example, the carbonator 18 can be a cavitation carbonator. The cavitation carbonator can preferably comprise several parallel channels for carbonating the liquid.

Preferably, the cavitation carbonator can accelerate the liquid using a pump so that the liquid reaches a velocity at which a pressure of the liquid falls below a vapor pressure of the liquid. The liquid can at least partially vaporize. The gaseous carbon dioxide can be introduced into the vaporized liquid and mix therewith. Due to the vaporization or the formation of vapor bubbles, the liquid flow can break apart. The flow velocity can decrease accordingly and the pressure can rise again above the vapor pressure. The mixture can return to a liquid state.

The additional filling material source 20 can provide an additional filling material or dosage filling material, preferably in liquid or pasty form. For example, the additional filling material can be (temporarily) stored in the additional filling material source 20. For example, the additional filling material source 20 can be realized as a tank, a boiler, a reservoir or a supply line. Preferably, the additional filling material source 20 can provide a syrup as the additional filling material.

The additional filling material source 20 can lead, via a pipeline, into a pipeline portion which is arranged downstream of the carbonator 18, as shown in FIG. 1. The pipeline portion can be located upstream of the liquid reservoir 24. For example, the pipeline portion can connect the carbonator 18 to the liquid reservoir 24 and/or the filling valve 26.

Alternatively, it is possible, for example, for the additional filling material source 20 to lead into a pipeline portion, via a line, wherein the pipeline portion is arranged upstream of the carbonator 18 (not shown in the figures). The pipeline portion can, for example, connect the water supply 14 and/or the degasser 16 to the carbonator 18.

The additional filling material can be metered via a metering valve 22 into the (not yet or already carbonated) liquid in the pipeline portion. The metering valve 22 can be arranged downstream of the additional filling material source 20. For example, the metering valve 22 can be arranged in the pipeline that connects the additional filling material source 20 to the pipeline portion upstream or downstream of the carbonator 18.

Preferably, the metering valve 22 can be a switching valve. The metering valve 22 can, for example, be switched to an open position and a closed position. In the open position, the metering valve 22 can release the line for the additional filling material to pass through. In the closed position, the metering valve 22 can close or block the pipeline. The metering valve 22 can be actuated in any conceivable way, e.g., electrically, electromagnetically, pneumatically, hydraulically or mechanically.

The system 10 can comprise several additional filling material sources, each optionally connected to a metering valve (not shown in the figures). The additional filling material sources can contain the same or different additional filling materials. The (mixed) filling material in container 12 can also contain additional filling materials from one, two or more additional filling material sources.

The liquid reservoir 24 is configured to store the carbonated liquid under pressure. For example, the liquid reservoir 24 can be a filling material tank.

The liquid reservoir 24 can be connected to the carbonator 18 in order to receive the carbonated liquid from the carbonator 18, e.g., via the piping system 38. The liquid reservoir 24 can be connected to the filling valve 26 in order to supply the carbonated liquid to the filling valve 26, e.g., via the piping system 38.

The filling valve 26 can be part of a filling apparatus. The filling apparatus can preferably be realized as a filler carousel or a rotary filling apparatus. The filling apparatus can comprise several of the filling valves 26 for filling several containers 12 simultaneously or overlapping in time. For example, the filling valves 26 can be arranged around a circumference of the filling apparatus realized as a filler carousel. Alternatively, the filling apparatus can be realized as a linear filler with several filling valves 26 arranged in series next to one another and/or one behind the other. Alternatively, it is also possible for the filling apparatus to have only a single filling valve 26, e.g., when the system 10 is designed as a small-scale system.

The filling apparatus can also comprise the liquid reservoir 24 and/or the piping system 38.

The filling valve 26 is connected to the carbonator 18 in order to receive the carbonated liquid from the carbonator 18, e.g., via the liquid reservoir 24 and/or the piping system 38.

The filling valve 26 is configured to continuously reduce the pressure of the carbonated liquid to below the saturation pressure and to above or substantially equal to an ambient pressure.

Preferably, the filling valve 26 is adjustable, using either closed-loop or open-loop control.

For example, the filling valve 26 may have a throttle element 28 for continuously reducing the pressure. The throttle element 28 can have a conical shape. The throttle element 28 can expand along a flow direction of the liquid or taper against a flow direction of the liquid.

The throttle element 28 can be movable (e.g. slidable) along its longitudinal axis, e.g., using an actuator. By moving along the longitudinal axis, the throttle element can adjust a flow cross-section through a sleeve-shaped gap of the filling valve 26 in order to regulate a flow of the liquid. The sleeve-shaped gap can be formed between a valve housing and the throttle element. For example, the sleeve-shaped gap can have a conical shape. It is possible for the sleeve-shaped gap to be completely closed when the throttle element 28 is in a closed position.

Optionally, the filling valve 26 can have a shut-off element 30 which is movable along its longitudinal axis for shutting off the filling valve 26. Using the preferably conical shut-off element 30, for example, an annular gap of the filling valve 26 can be opened or closed.

The throttle element 28 and/or the shut-off element 30 can be actuated in any conceivable way, e.g., electrically, electromagnetically, pneumatically, hydraulically or mechanically.

It is also possible for the shut-off function to be taken over by the throttle element 28 and for the filling valve 26 not to comprise a separate shut-off element 30 (not shown in the figures).

The filling valve 26 is configured to fill the container 12. Preferably, the filling valve 26 can fill the container 12 via wall-filling or through a filling tube (long-tube filling).

In the case of wall-filling, the liquid can be introduced into the container 12 in such a way that it flows downward along an inner circumferential surface of the container 12 and fills the container. For example, a flow body 32, which can be arranged at an outlet of the filling valve 26, deflects the exiting liquid toward the inner circumferential surface of the container 12. The flow body 32 can be conical in shape, for example. The flow body 32 can be realized as a deflection shield, for example. Alternatively or additionally, the flow body 32 can comprise, for example, a helical liquid channel. The helical liquid channel can impart a swirl to the liquid to ensure it adheres to the inner circumferential surface of the container. Alternatively, the swirl can also be generated by the tangential inflow into a torus arranged around the shut-off element.

As an alternative to the flow body 32 or wall-filling, the container 12 can be filled through a filling tube 34, for example in the case of filling through a filling tube (long tube-filling). The filling tube 34 can be immersed in the container 12. The filling tube 34 can, for example, extend to the middle section of the container 12 or further downward toward the bottom of the container 12.

The container 12 can be positioned below the filling valve 26 during the filling process.

It is possible for the container 12 and the filling valve 26 to be brought closer to each other for filling with respect to a vertical direction. For example, a lifting device 36 may be included. The lifting device 36 can be configured to raise and lower the container 12, the filling valve 26, and/or the filling tube 34. Using the lifting device 36, it is also possible to immerse the filling tube 34 into the container 12.

For example, the lifting device 36 can be coupled to a container holder for holding the container 12 in order to raise and lower the container holder. The container holder can support the container 12, for example, at its container neck, container neck ring, container base or container bottom.

It is also possible for the container 12 to be pressed against the filling valve 26 during filling. For example, the lifting device 36 can be configured to raise and lower the container 12 and/or the filling valve 26 in order to press the filling valve 26 and the container 12 together.

Alternatively, the filling valve 26 and the container 12 can be spaced apart from each other during filling.

The piping system 38 can connect the carbonator 18 and the filling valve 26. For example, the piping system 38 can comprise a line connecting the carbonator 18 and the liquid reservoir 24. The piping system 38 can also comprise a line connecting the liquid reservoir 24 to the filling valve 26. It is possible for the piping system 38 to comprise at least one further line, such as a line connecting the liquid supply 14 and the degasser 16 and/or a line connecting the degasser 16 and the carbonator 18.

Preferably, the internal surface of the piping system 38 has a mean roughness value Ra≤0.8. At no point in the piping system 38 should the internal surface have a mean roughness value Ra>0.8. The piping system 38 may be free of dead zones, sudden expansions of the flow cross-section and/or sudden contractions of the flow cross-section. A maximum angle for continuous expansions of the flow cross-section and continuous contractions of the flow cross-section of the piping system 38 can be ≤6°.

It is possible for additional sensor technology and/or valve technology to be arranged in the piping system 38. For example, a flow measuring device can be arranged in a pipeline portion between the liquid reservoir 24 and the filling valve 26 in order to measure a flow of the liquid toward the filling valve 26. For example, a valve can be arranged in a line portion between the liquid reservoir 24 and the filling valve 26 in order to adjust (throttle) a flow of the liquid and/or block or shut off the pipeline portion.

The closure apparatus 40 can seal the containers 12, e.g., with a lid, a cork, a crown cap or a screw cap. The closure apparatus 40 can preferably be realized as a closure carousel or a rotary closure apparatus. The closure apparatus can have several closure stations for simultaneously sealing several containers 12. For example, the closure stations can be arranged around a circumference of the closure apparatus realized as a closure carousel. The closure apparatus 40 can be arranged downstream of the filling valve 26 or filling apparatus in relation to a container flow.

The closure apparatus 40 and the filling valve 26 or the filling apparatus can be connected to each other using a container conveyor. The container conveyor can, for example, have at least one transport starwheel and/or at least one linear conveyor.

With reference to FIGS. 1 and 2, a method for filling containers 12 is explained below.

First, a liquid, preferably pure water (water without additives), can be fed from the liquid supply 14 to the degasser 16.

In a step S10, the liquid can be degassed using the degasser 16. In this process, gaseous oxygen dissolved in the liquid can be reduced.

In a step S12, the liquid is carbonated using the carbonator 18. During this process, gaseous carbon dioxide can dissolve in the liquid and form carbonic acid in reaction with water. Preferably, a pressure of the liquid during carbonation can correspond at least to the saturation pressure (equilibrium pressure) of carbon dioxide in the liquid.

During carbonation, either pure water or water mixed with at least one additional filling material can be carbonated.

It is possible for the degassing (step S10) to be performed together with carbonation of the liquid (S12) by a membrane contactor-degasser-carbonator.

In a step S14, at least one additional filling material from the at least one additional filling material source 20 can be metered into the liquid via the metering valve 22. The additional filling material can, for example, be metered into the already carbonated liquid, e.g., as shown in the setup in FIG. 1. The additional filling material can also be metered before the liquid is carbonated, whereby step S14 could be carried out before step S12 and optionally also before step S10.

In a step S16, the carbonated liquid, possibly mixed with at least one additional filling material, can be stored in the liquid reservoir 24. The carbonated liquid can flow from the carbonator 18 through the piping system 38 to the liquid reservoir 24. From the liquid reservoir 24, the carbonated liquid can flow through the piping system 38 to the filling valve 26.

In a step S18, the pressure of the carbonated liquid is continuously reduced to below a saturation pressure of the carbon dioxide in the carbonated liquid and to above or substantially equal to an ambient pressure using the filling valve 26. In particular, the throttle element 28 can reduce the pressure steadily and uniformly along its length.

In a step S20, the container 12 is filled with the pressure-reduced liquid using the filling valve 26. For this purpose, for example, the shut-off element 30 can be opened or lifted from its valve seat. As already mentioned, it is also possible for the throttle element 28 to also take over the shut-off function. For example, step S20 can be carried out simultaneously or overlapping in time with step S18.

During filling, the container 12 can have an internal pressure that corresponds to the pressure of the pressure-reduced liquid and/or the ambient pressure.

Preferably, step S20 involves wall-filling the container 12 or filling the container 12 using the filling tube 34.

It is possible that the container 12 is pressed against the filling valve 26 during filling, preferably in a gas-tight or liquid-tight manner.

In a step S22, the filled container 12 can be closed with a container closure by the closure apparatus 40.

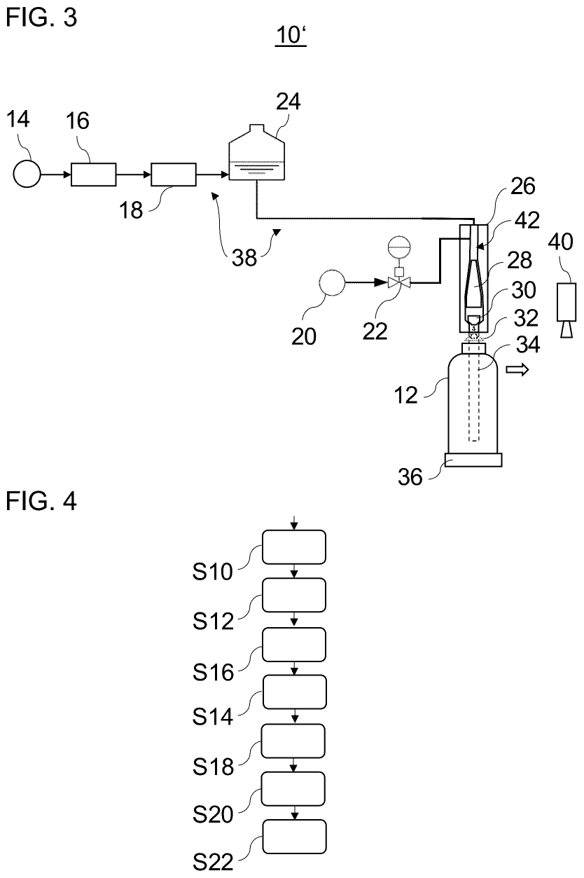

FIG. 3 shows a modified system 10′ in which the filling valve 26 has a mixing chamber 42.

In the mixing chamber 42, different filling materials from different filling material sources can be mixed together. Preferably, the filling materials can be mixed in the mixing chamber 42 when the filling valve 26 is closed. The container 12 can be filled from the mixing chamber 42 when the filling valve 26 is open.

The mixing chamber 42 can be realized as a swirl chamber, for example.

The mixing chamber 42 can, for example, be arranged upstream or downstream of the throttle element 28.

The additional filling material source 20 can be connected to the mixing chamber 42 via a line which opens into the mixing chamber 42. The additional filling material from the additional filling material source 20 can be metered into the liquid in the mixing chamber 42 using the metering valve 22.

In the associated method according to FIG. 4, step S14 of metering the at least one additional filling material into the liquid can take place after step S16 of storing the carbonated liquid in the liquid reservoir 24. Depending on an arrangement of the mixing chamber 42, it is also possible for step S14 of metering the at least one additional filling material into the liquid to take place after step S18 (continuous pressure reduction) and before step S20 (filling).

The invention is not limited to the preferred embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the sub-claims are also disclosed independently of all the features of independent claim 1. All ranges specified herein are to be understood as disclosed in such a way that all values falling within the relevant range are individually disclosed, e.g., also as the relevant preferred narrower outer limits of the relevant range.

### LIST OF REFERENCE SIGNS

10 system
12 container
14 liquid supply
16 degasser
18 carbonator
20 additional filling material source
22 metering valve
24 liquid reservoir
26 filling valve
28 throttle element
30 shut-off element
32 flow body
34 filling tube
36 lifting device
38 piping system
40 closure apparatus
42 mixing chamber

What is claimed is:

1. A method for filling a liquid into a container, wherein the method comprises:
carbonating the liquid using a carbonator;
continuously reducing a pressure of the carbonated liquid to below a saturation pressure of carbon dioxide in the carbonated liquid and to at least an ambient pressure using a filling valve; and
filling the container with the pressure-reduced liquid using the filling valve.

2. The method according to claim 1, wherein at least one of the following conditions is met:
the carbonating of the liquid is carried out using one of a membrane contactor carbonator, a cavitation carbonator, and a spray cone carbonator;
the carbonating is carried out using a bubble-free carbonation process;
during the carbonating, one of the liquid is vaporized into a gas and the gas is mixed with gaseous carbon dioxide, and gaseous carbon dioxide diffuses into the liquid during the carbonating without being forced into it; and
a pressure of the liquid during the carbonating corresponds at least to the saturation pressure of carbon dioxide in the liquid.

3. The method according to claim 1, wherein at least one of:
the filling of the container is carried out through a filling tube 34) which is immersed into the container;
the filling of the container is carried out by wall-filling of the container, in which the liquid flows into the container along an inner circumferential face of the container as the container is filled; and
the filling of the container is not carried out by free-jet filling.

4. The method according to claim 1, wherein at least one of:
when the container is filled with the pressure-reduced liquid, the container has an internal pressure which corresponds to the pressure of at least one of the pressure-reduced liquid and the ambient pressure, and
the filling is carried out at ambient pressure.

5. The method according to claim 1, wherein at least one of:
the container is pressed against the filling valve during filling, and
the filling valve is one of several filling valves of a rotary filling apparatus.

6. The method according to claim 5, wherein the container is pressed against the filling valve during the filling in one of a gas-tight and a liquid-tight manner.

7. The method according to claim 1, further comprising:
flowing of the carbonated liquid through a piping system to the filling valve, wherein at least one of the following conditions is met:
the internal surface of the piping system has a mean roughness value Ra≤0.8;
the piping system is free of at least one of dead zones, sudden expansions of a flow cross-section and sudden contractions of a flow cross-section; and
a maximum angle for continuous expansions of a flow cross-section and continuous contractions of a flow cross-section of the piping system is ≤6°.

8. The method according to claim 1, further comprising:
storing the carbonated liquid in a liquid reservoir before the pressure is reduced by the filling valve.

9. The method according to claim 1, further comprising one of:
flowing of the carbonated liquid through a piping system to the filling valve with an interposition of a liquid reservoir; and
storing the carbonated liquid in a liquid reservoir before the pressure is reduced by the filling valve, wherein the carbonated liquid is stored under a pressure which corresponds at least to the saturation pressure of carbon dioxide in the carbonated liquid.

10. The method according to claim 1, further comprising:
degassing the liquid using a degasser one of before and during the carbonating of the liquid to reduce gaseous oxygen in the liquid.

11. The method according to claim 1, wherein:
the liquid being carbonated is one of pure water and water mixed with at least one additional filling material.

12. The method according to claim 1, further comprising:
metering at least one additional filling material into the liquid.

13. The method according to claim 12, wherein the metering is one of:
before the carbonating;
after the carbonating and before reducing the pressure; and
into a mixing chamber of the filling valve.

14. The method according to claim 1, wherein at least one of the following conditions is met:
the method further comprises sealing the filled container with a container closure using a closure apparatus;
the container is at least one of automatically moved to the filling and automatically moved away after the filling;
the method is applied in a container treatment system;
the filling valve is one of several filling valves of a filling apparatus; and
the container moves along a continuous production line.

15. A system for filling a liquid into containers, the system comprising:
a carbonator configured to carbonate the liquid; and
a filling apparatus having at least one filling valve connected to the carbonator in order to receive the carbonated liquid from the carbonator and configured to:
continuously reduce the pressure of the carbonated liquid to below the saturation pressure and to at least an ambient pressure, and
fill a container with the pressure-reduced liquid.

16. The system according to claim 15, further comprising at least one of the following:
a liquid reservoir for storing the carbonated liquid, wherein the liquid reservoir is connected to the carbonator in order to receive the carbonated liquid, and to the filling valve in order to supply the carbonated liquid to the filling valve;
a closure apparatus for sealing filled containers with a container closure;
at least one additional filling material source which is connected to one of:
a pipeline portion one of upstream and downstream of the carbonator for metering an additional filling material into the liquid in the pipeline portion; and
a mixing chamber of the filling valve for metering an additional filling material into the liquid in the mixing chamber;
a liquid supply connected to the carbonator in order to supply liquid to the carbonator;
a degasser configured to reduce gaseous oxygen in the liquid and one of integrated with the carbonator and connected to the carbonator in order to supply the degassed liquid to the carbonator;
a lifting device configured to raise and lower at least one of the container and the filling valve in order to press the filling valve and the container together;
a piping system connecting the carbonator and the filling valve, wherein the piping system at least one of:
has an internal surface with a mean roughness value Ra≤0.8;
is at least one of free from dead zones, sudden expansions of a flow cross-section and sudden contractions of a flow cross-section; and
has a maximum angle for continuous expansions of a flow cross-section and continuous contractions of a flow cross-section of ≤6°.

17. The system according to claim 16, wherein the liquid supply includes a water supply.

18. The system according to claim 15, wherein at least one of:
the carbonator is one of a membrane contactor carbonator, a cavitation carbonator and a spray cone carbonator;
the carbonator is configured to carry out a bubble-free carbonation process,
the carbonator is configured to one of vaporize the liquid into a gas during carbonization and to mix this gas with gaseous carbon dioxide, and to allow gaseous carbon dioxide to diffuse into the liquid during carbonation without the gaseous carbon being forced into the liquid; and
the carbonator is configured to carbonate the liquid at a pressure which corresponds at least to the saturation pressure of carbon dioxide in the liquid.

19. The system according to claim 15, wherein one of:
the system is an industrial container treatment system; and
the system is a small-scale system for installation in one of a supermarket and a railway station, with a footprint ≤10 sqm.

20. The system according to claim 15, wherein at least one of:
the filling apparatus is configured to continuously reduce the pressure of the carbonated liquid to below the saturation pressure and to at least the ambient pressure using a throttle element of the filling valve;
the filling apparatus is configured to fill the container with the pressure-reduced liquid one of through a filling tube and by wall-filling the container;
the system is a small-scale system for installation in one of a supermarket and a railway station with a footprint ≤10 sqm; and
the system fills the liquid into the containers using a method of:
carbonating the liquid using the carbonator, continuously reducing the pressure of the carbonated liquid to below the saturation pressure of carbon dioxide in the carbonated liquid and to at least the ambient pressure using a filling valve, and
filling the container with the pressure-reduced liquid using the filling valve.
